(19) United States
(12) Patent Application Publication
(10) Pub. No.: US 2003/0162493 A1
(43) Pub. Date: Aug. 28, 2003

(54) Method and apparatus for providing broadcasting program guide information

(75) Inventor: Kyung-ah Kim, Seoul (KR)

Correspondence Address: SUGHRUE MION, PLLC, 2100 Pennsylvania Avenue, NW, Washington, DC, 20037-3213, US

(73) Assignee: SAMSUNG ELECTRONICS CO., LTD.

(21) Appl. No.: 10/338,882

(22) Filed: Jan. 9, 2003

(30) Foreign Application Priority Data
Jan. 9, 2002 (KR) 2002-1194

(51) Int. Cl. H04H 1/00

(52) U.S. Cl. 455/3.01; 455/3.06

(57) ABSTRACT

A method and apparatus for providing guide information relating to broadcasting programs while minimally blocking the screen of a program that is currently being watched. First, guide information included in a received broadcasting signal is detected as first guide information and stored. Next, guide information relating to highlight or recommended programs designated by channels or broadcasting stations through a network, is received and stored as second guide information. Thereafter, if the guide information relating to broadcasting programs is requested, guide information relating to programs being currently broadcast through channels is detected as third guide information from the first guide information. Then, the second and third guide information is displayed.

### BACKGROUND OF THE INVENTION

This application claims the priority of Korean Patent Application No. 2002-1194, filed Jan. 9, 2002, in the Korean Intellectual Property Office, the disclosure of which is incorporated herein in its entirety by reference.

1. Field of the Invention

The present invention relates to a method and device for providing guide information relating to broadcasting programs, and more particularly, to a method and apparatus for providing various types of guide information relating to broadcasting programs.

2. Description of the Related Art

Related art broadcasting receivers receive and store an electronic program guide (EPG), which is regularly transmitted by a broadcasting station. The EPG is a guide relating to programs transmitted by broadcasting stations, and includes broadcasting programs' titles, broadcasting programs' channel numbers, broadcasting programs' broadcasting times, and the detailed descriptions or contents of the broadcasting programs. A ground wave receiving system, which receives and stores the EPG, can provide guide information regarding broadcasting programs from the stored EPG.

At present, guide information relating to broadcasting programs as shown in FIG. 1 is provided when a user requests a program guide. While a program image being currently watched is scaled down or deleted, a broadcasting program guide is displayed over substantially the entire screen. The displayed guide does not include only a currently broadcast program, but also includes information relating to programs broadcast at different time slots.

Hence, the related art method of providing a broadcasting program guide can provide a large quantity of guide information. However, the related art has various problems and disadvantages. For example, but not by way of limitation, while a broadcasting program guide is being provided, a program that the user currently wishes to watch cannot be properly watched.

In addition, when a user requests a broadcasting program guide to change the current channel to another channel, it is difficult to glance at the contents of programs currently being provided on different channels because of the screen of a related art program guide as shown in FIG. 1. This complicates channel navigation, and consequently hinders fast selection of a desired channel. This problem occurs more clearly when the number of channels that can be watched is relatively large, for example, 30 channels or more.

Furthermore, a broadcasting program guide provided in the conventional manner only includes information such as broadcasting time, broadcasting channels, program names, as shown in FIG. 1, but does not provide information regarding highlighted programs or programs recommended by broadcasting stations or channels.

### SUMMARY OF THE INVENTION

To solve the above and other problems, it is an aspect of the present invention to provide a method and apparatus for providing guide information relating to broadcasting programs while minimally blocking the screen for a program that is currently watched.

Another aspect of the present invention is to provide a method and apparatus for providing guide information relating to broadcasting programs to facilitate channel navigation based on the provided guide information.

Still another aspect of the present invention is to provide a method and apparatus for providing guide information relating to broadcasting programs, by which guide information relating to highlight or recommended programs designated by broadcasting stations or channels is provided.

The above and other aspects of the present invention are achieved by a method of providing guide information relating to broadcasting programs, in which if guide information relating to broadcasting programs is requested, the guide information relating to programs currently broadcast through channels is first detected from stored guide information. Then, the detected guide information is displayed.

Preferably, in the display step, the detected guide information is displayed in only a part of a displayable area.

The above and other aspects of the present invention are also achieved by a method of providing guide information relating to broadcasting programs, in which, first, guide information relating to a highlight or recommended program designated by a channels or broadcasting station is received via a communications network, such as the Internet, and stored. Thereafter, if the guide information relating to broadcasting programs is requested, outline information among the guide information stored in the storing step is displayed.

Preferably, in the display step, the outline information is displayed in only a part of a displayable area. It is also preferable that the outline information includes a still image or icon corresponding to the program. Preferably, the outline information includes a snapshot or moving picture corresponding to the program.

It is also preferable that when outline information relating to a desired program is selected, the display step further includes a substep of detecting detailed guide information relating to the selected program from the guide information and displaying the detected detailed guide information.

The above and other aspects of the present invention are still achieved by a method of providing guide information relating to broadcasting programs, in which guide information included in a received broadcasting signal is first detected and stored as first guide information. Thereafter, guide information relating to highlight or recommended programs designated by channels or broadcasting stations is received through a network, such as the Internet, and the received guide information is stored as second guide information. Next, if the guide information relating to broadcasting programs is requested, guide information relating to programs being currently broadcast through channels is detected as third guide information from the first guide information. Then, the second guide information and third guide information are displayed.

Preferably, if guide information by broadcasting category is requested, the method further includes displaying the pre-set guide information by broadcasting category in an area in which the third guide information is displayed.

It is also preferable that when the first guide information is requested while the second and third guide information are displayed, the method further includes displaying the first guide information over the entire displayable area.

The above and other aspects of the present invention are also achieved by an embodiment of an apparatus for providing guide information relating to broadcasting programs. In this embodiment, a guide information detector detects guide information from a received broadcasting signal. A storage unit stores the detected guide information. If a user requests guide information, a system controller controls the storage unit so that the storage unit outputs guide information relating to programs that are currently broadcast through channels among the stored guide information. A display unit displays the guide information output from the storage unit in only a part of a displayable area.

The above and other aspects of the present invention are also achieved by another embodiment of an apparatus for providing guide information relating to broadcasting programs. In this embodiments, a storage unit receives guide information relating to highlighted or recommend programs designated by a channel or broadcasting station via a communication network, such as the Internet, and stores the received guide information. If a user requests guide information, a system controller controls the storage unit so that the storage unit outputs outline information among the stored guide information. A display unit displays the outline information output from the storage unit in only a part of a displayable area.

The above and other aspects of the present invention are also achieved by still another embodiment of an apparatus for providing guide information relating to broadcasting programs. In this embodiment, a guide information detector detects guide information from a received broadcasting signal. A first storage unit stores as first guide information the guide information detected by the guide information detector. A second storage unit stores as second guide information guide information relating to a highlighted or recommended programs designated by a channel or broadcasting station through a network, such as the Internet. If a user requests the guide information relating to broadcasting programs, a system controller controls the first storage unit so that the first storage unit outputs as third guide information guide information relating to programs being currently broadcast through channels among the first guide information, and controls the second storage unit so that the second storage unit outputs as fourth guide information outline information among the second guide information. A display unit displays the third and fourth guide information in part of a displayable area.

### BRIEF DESCRIPTION OF THE DRAWINGS

The above and other aspects and advantages of the present invention will become more apparent by describing in detail preferred embodiments thereof with reference to the attached drawings in which:

FIG. 1 shows an example of a screen in order to explain a related art method of providing a broadcasting program guide;

FIG. 2 is a conceptual diagram of a method according to a non-limiting, exemplary embodiment of the present invention of providing a broadcasting program guide;

FIG. 3A shows an example of a screen of a broadcasting program guide provided according to a non-limiting, exemplary embodiment of the present invention;

FIG. 3B shows an example of a screen of detailed guide information regarding a broadcasting program according to a non-limiting, exemplary embodiment of the present invention;

FIG. 4 is a block diagram of a receiving system including an apparatus for providing guide information relating to broadcasting programs, according to a non-limiting, exemplary embodiment of the present invention; and

FIGS. 5A and 5B show a flowchart illustrating a method of providing guide information relating to broadcasting programs, according to a non-limiting, exemplary embodiment of the present invention.

### DETAILED DESCRIPTION OF THE INVENTION

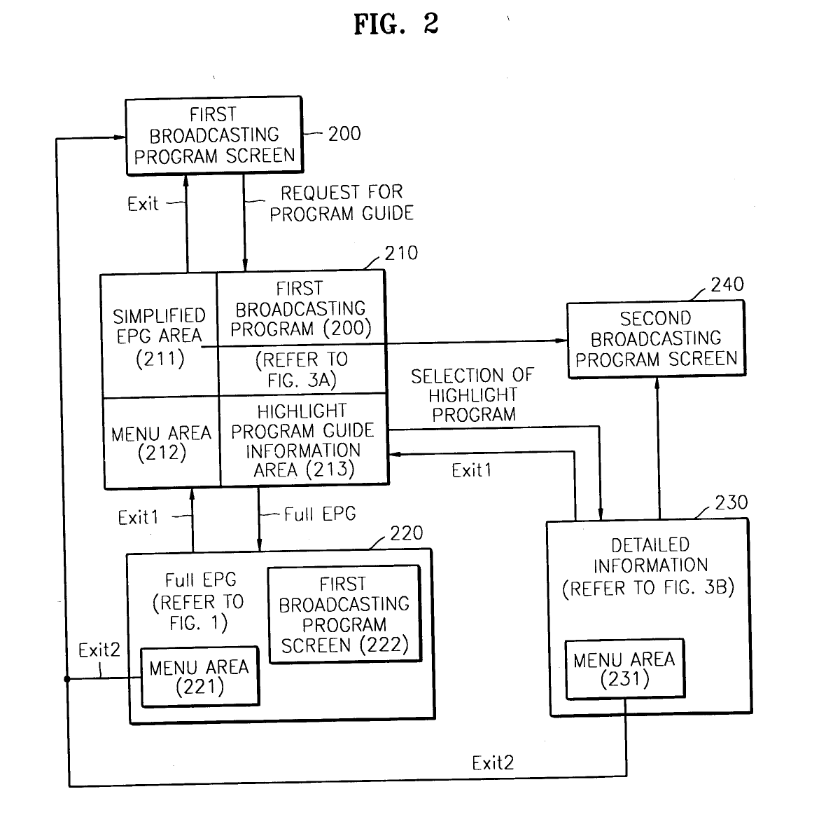

Referring to FIG. 2, when a user requests a broadcasting program guide while a first broadcasting program screen 200, which is currently being watched, is displayed, a screen 210 containing guide information relating to broadcasting programs is displayed. In the screen 210, simplified electronic program guide (EPG) information is displayed over an area 211 of the first broadcasting program screen 200. Menu information for selecting a function is displayed over an area 212 of the screen 200, and guide information relating to highlighted or recommended programs is displayed over an area 213 of the screen 200.

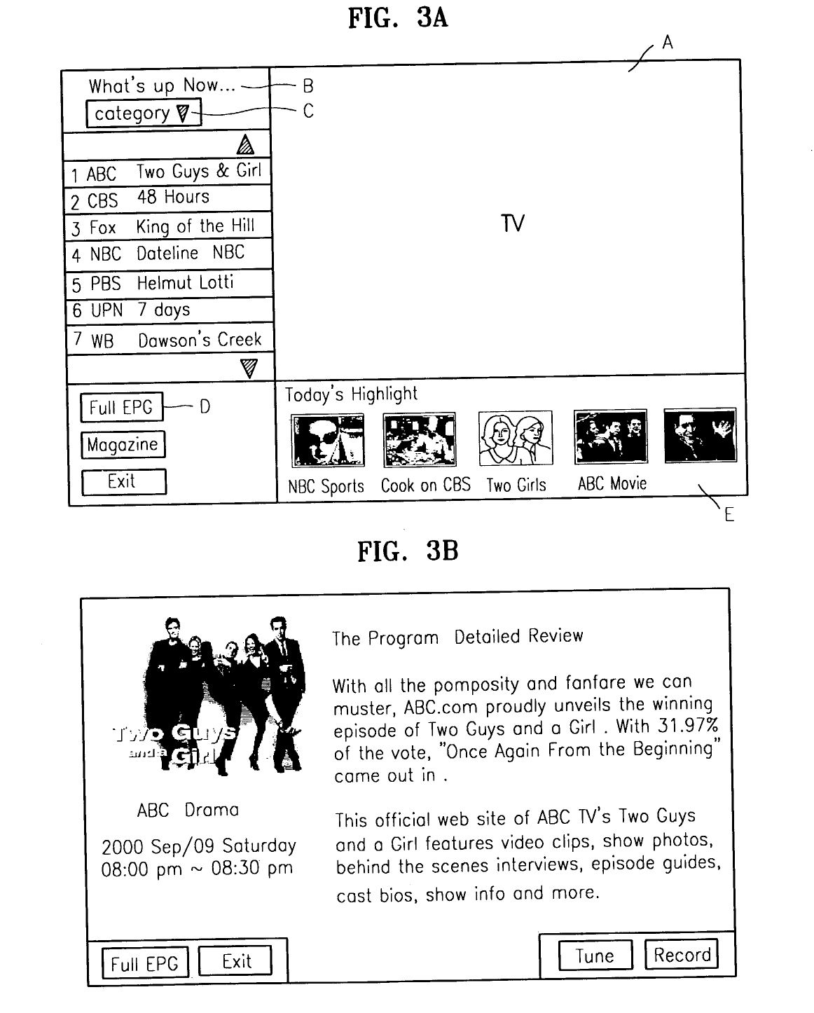

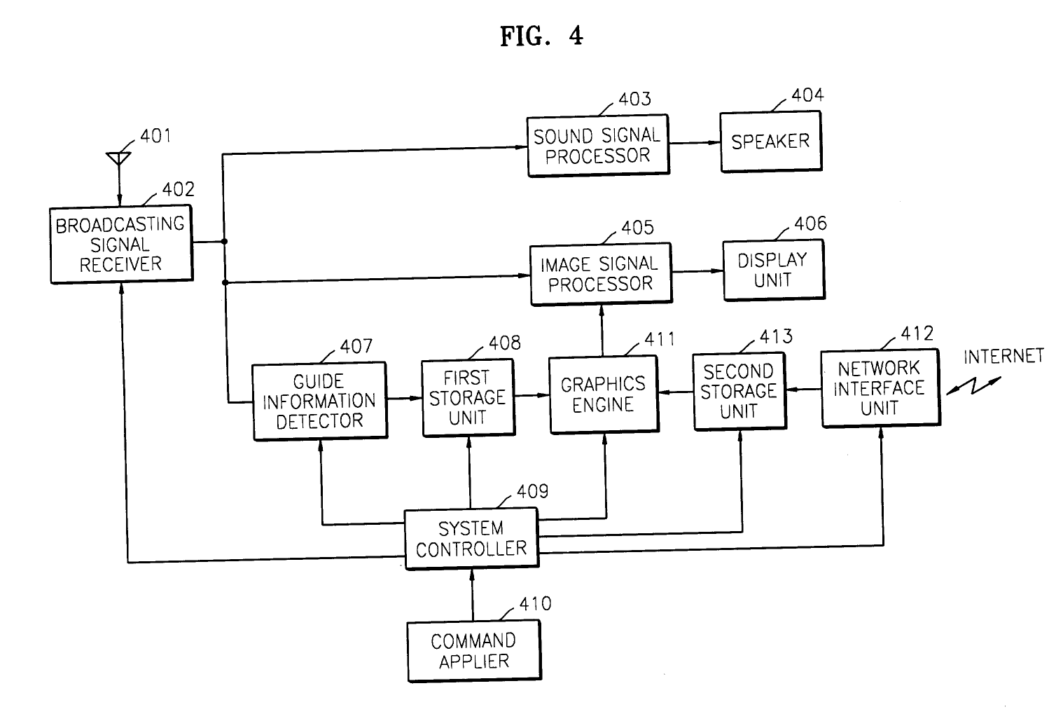

The screen 210 is similar to the screen of FIG. 3A. In FIG. 3A, area A, which is indicated by a TV, corresponds to the currently-watched broadcasting program screen 200 in the screen 210, area B corresponds to the simplified EPG area 211, and area C is controlled to search for a list of broadcasting programs classified by category. The area C may be set in the menu area 212. Area D corresponds to the menu area 212, and area E corresponds to the highlight program guide information area 213.

By controlling an up and down direction key or a direction button on area B of FIG. 3A, simplified EPG information relating to channels other than the currently displayed channel is displayed. EPG information corresponds to guide information relating to broadcasting programs. Hence, the EPG information can be expressed in a different word that denotes guide information relating to broadcasting programs.

When a key ‘Exit’ included in the menu area 212 (area B) is controlled while the screen 210 is being displayed, the screen 200 re-appears on the entire TV screen. The key ‘Exit’ is used to terminate a current operation. The screen 200, which is for a broadcasting program being currently broadcast, changes displayed contents in real time. The return from the screen 210 to the screen 200 means going back to a routine in which the currently received broadcasting program is normally watched. The TV program screen shown on the screen 210 turns into the same size as the screen 200.

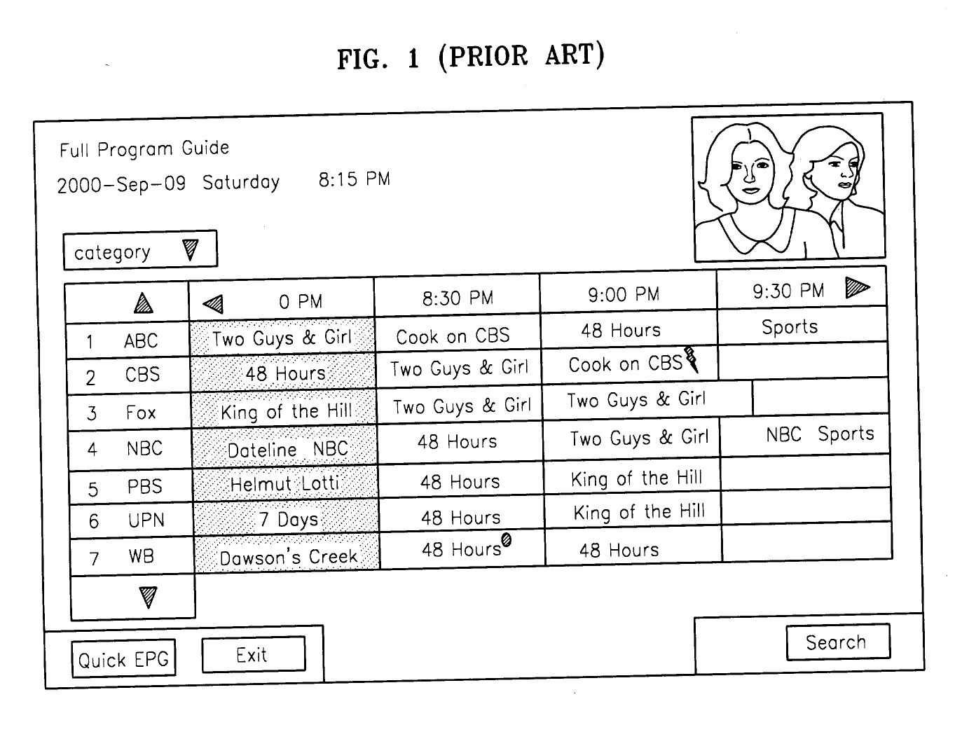

On the other hand, when an item “full EPG” included in the menu area 212 (area B) on the screen 210 is selected, a broadcasting program guide is displayed over the entire displayable area as shown in a screen 220. The item “full EPG” denotes a request for guide information relating to all broadcasting programs. Accordingly, when a user wants to receive a broadcasting program guide as shown in FIG. 1 and selects the item “full EPG” in the menu area 212 (area B), the screen 210 containing the simplified EPG area 211 turns into the screen 220 displaying the full EPG of FIG. 1. A screen 222 denotes the screen 200 whose size has been reduced by scaling.

When an item “Exit 1” included in a menu area 221 on the screen 220 is controlled, the screen 220 returns to the screen 210. On the other hand, when an item “Exit 2” included in the menu area 221 is controlled, the screen 220 returns to the screen 200. The items “Exit 1” and “Exit 2” on the menu area 221 can be configured to be a single item. In this case, when the single Exit item is controlled, the screen 220 returns to either the screen 210 or the screen 200.

When a highlight program is selected from the highlight programs provided in the highlight program guide information area 213 on the screen 210, detailed information regarding the selected highlight program is displayed as in a screen 230. The screen 230 corresponds to the screen of FIG. 3B. When an item “Exit 1” in a menu area 231 on the screen 230 is selected, the screen 230 returns to the screen 210. When an item “Exit 2” in the menu area 231 on the screen 230 is selected, the screen 230 returns to the screen 200. As described above with respect to the menu area 221, the items “Exit 1” and “Exit 2” in the menu area 231 can also be configured to be a single item. In this ease, when the single Exit item is controlled, the screen 230 returns to either the screen 210 or the screen 200.

When a channel is selected in the simplified EPG area 211 on the screen 210, the selected channel is tuned, and a second broadcasting program screen 240 for displaying broadcasting programs provided via the selected channel is displayed. The screen 240 can also change in real time.

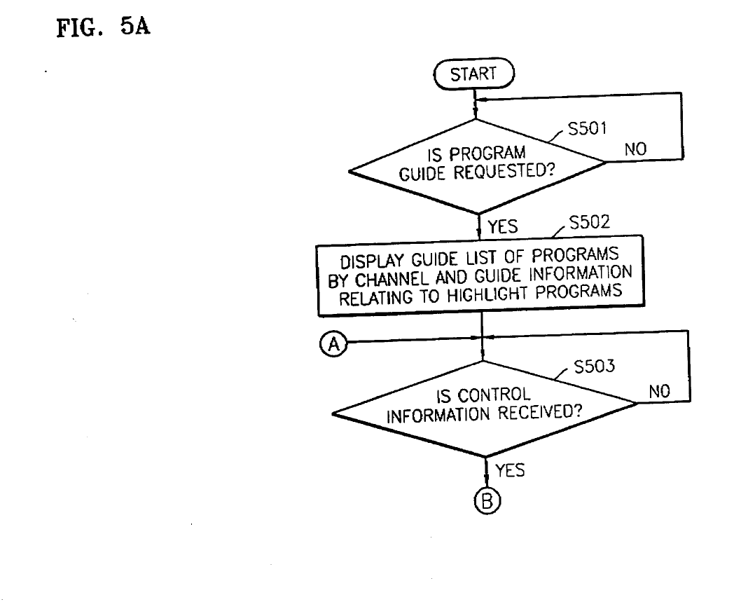

FIG. 4 is a block diagram of a receiving system including an apparatus for providing guide information relating to broadcasting programs, according to a non-limiting, exemplary embodiment of the present invention. The receiving system includes an antenna 401, a broadcasting signal receiver 402, a sound signal processor 403 coupled to a speaker 404, an image signal processor 405 coupled to a display unit 406, a guide information detector 407, a first storage unit 408, a system controller 409, a command applier 410, a graphics engine 411, a network interface unit 412, and a second storage unit 413.

The broadcasting signal receiver 402, which serves as a tuner, is controlled by the system controller 409 and receives a broadcasting signal corresponding to a tuned channel among broadcasting signals received via the antenna 401. The received broadcasting signal corresponds to information that includes broadcasting programs and guide information relating to the broadcasting programs. For example, but not by way of limitation, the broadcasting program guide information is the above-described EPG information. The broadcasting signal receiver 402 transmits a sound signal included in the received broadcasting signal to the sound signal processor 403, and an image signal included in the received broadcasting signal to the image signal processor 405.

The sound signal processor 403 operates as a related art sound signal processing circuit included in an existing receiving system. If the receiving system is a digital TV or a settop box similar to a digital TV, the sound signal processor 403 is designed to decode the received sound signal and convert the decoded sound signal into analog sound data. The sound data output by the sound signal processor 403 can be recognized by a user (or a viewer) through the speaker 404.

The image signal processor 405 processes the image signal received from the broadcasting signal receiver 402 so that the received image signal can be displayed on the display unit 406. If the receiving system is a digital TV or a settop box similar to a digital TV, the image signal processor 405 decodes the received image signal and RGB-encodes the decoded image signal to produce an image signal that can be displayed on the display unit 406. 1411 In particular, the image signal processor 405 adds screen information, which includes information such as guide information received from the graphics engine 411, to an image signal to be currently produced, and transmits the image signal to which the screen information has been attached to the display unit 406. The screen information received from the graphics engine 411 can be displayed either on the entire screen of the display unit 406 or on a partial area of the screen of the display unit 406.

The guide information detector 407 detects only guide information from the image signal received from the broadcasting signal receiver 402. Since the transmitted guide information is included in a particular area of an image signal packet, the guide information can be obtained by decoding information of the particular area. The guide information includes receivable broadcasting programs or detailed information regarding the receivable broadcasting programs. In the case of ground wave receiving systems, the guide information corresponds to an EPG. The detected guide information is stored in the first storage unit 408.

The network interface unit 412 is coupled to a communications network, such as the Internet, under the control of the system controller 409, and receives guide information relating to highlighted or recommended programs by channels or broadcasting stations via the communications network. The guide information relating to highlighted or recommended programs can be provided from an Internet server managed by a broadcasting station, as well as an Internet server independent of a broadcasting station. In other words, the guide information relating to highlighted or recommended programs can be provided by an Internet server that is managed by a different Internet service provider.

The guide information relating to highlighted or recommended programs includes outline information and detailed information. As shown on the highlight program guide area E of FIG. 3A, the outline information includes highlight programs' names, the broadcasting stations or channels of the highlight programs, and the still pictures (or icons) or moving pictures (or snapshots) of the highlight programs. The detailed information contains information such as shown in FIG. 3B. The received guide information is transmitted to the second storage unit 413.

The second storage unit 413 stores the outline information and the detailed information separately. Various methods of storage are possible, but a method of storage in which the detailed information is searched based on the outline information is adopted. The second storage unit 413 can be implemented so that the outline information and the detailed information are stored in different storage devices, or a single storage device.

The graphics engine 411 is controlled by the system controller 409 and forms a display format of the broadcasting program guide information received from the first storage unit 408 and a display format of the guide information received from the second storage unit 413. Accordingly, the received information is displayed by overlapping a TV screen in an L shape as shown in FIG. 3A. The guide information output from the graphics engine 411 must be an analog signal, so that the guide information can immediately overlap the image signal in the image signal processor 405.

When the system controller 409 receives a signal from the command applier 410 indicating a request for broadcasting program guide information, the system controller 409 controls the first storage unit 408 so that guide information relating to broadcasting programs currently provided via channels is detected, and the detected guide information is output to the graphics engine 411. The system controller 409 also controls the graphics engine 411 so that the guide information output from the first storage unit 408 is displayed on the simplified EPG area 211 of FIG. 2 or the area B of FIG. 3A.

The system controller 409 also controls the second storage unit 413 so that the outline information is detected from the guide information relating to highlighted or recommended information stored in the second storage unit 413 and output to the graphics engine 411. The system controller 409 controls the graphics engine 411 so that the outline information output from the second storage unit 413 is displayed on the highlight program guide information area 213 of FIG. 2, or the area E of FIG. 3A.

When the system controller 409 receives a request for a conventional full EPG from the command applier 410, the system controller 409 controls the first storage unit 408, the graphics engine 411, and the image signal processor 405 so that all of the guide information stored in the first storage unit 408 is displayed over the entire screen, as shown in FIG. 1, with the currently-being-watched broadcasting program scaled and diminished in size.

The command applier 410 not only inputs data and commands necessary to provide broadcasting program guide information in a manner according to the present invention, but also inputs data and commands necessary to perform the other operations of a receiving system.

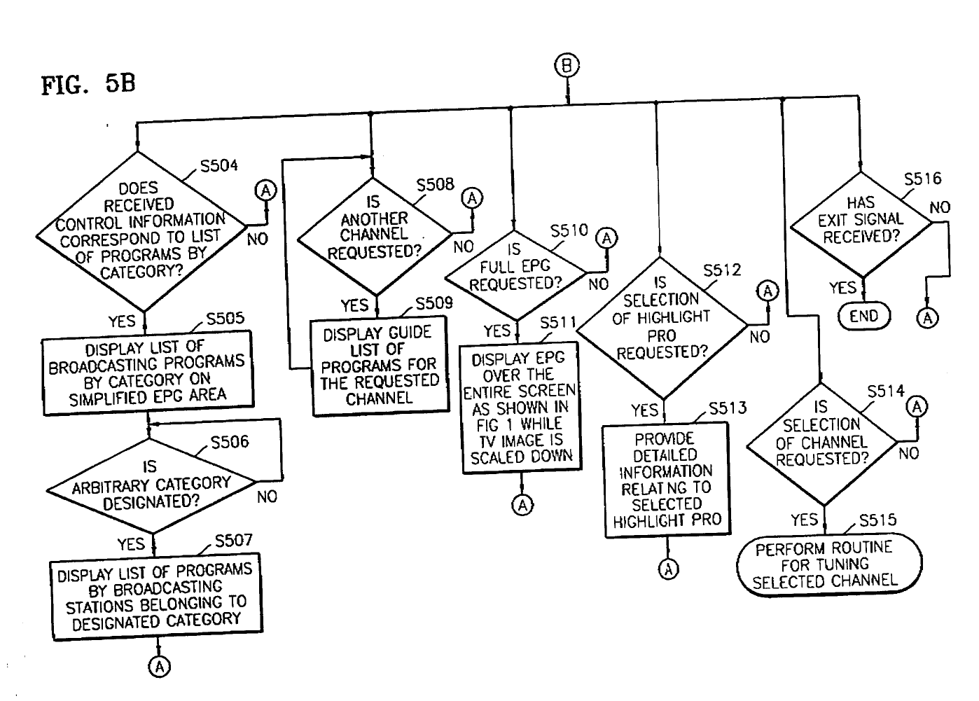

FIGS. 5A and 5B are flowcharts illustrating a method of providing a broadcasting program guide, according to an exemplary, non-limiting embodiment of the present invention. The operation of FIGS. 5A and 5B is performed on the assumption that guide information included in a received broadcasting signal is stored in the first storage unit 408 and that guide information relating to highlighted or recommended programs is stored in the second storage unit 413.

When a program guide is required through the command applier 410 in step S501, the system controller 409 displays a guide list of programs by channels and guide information relating to highlight programs (PRO) as shown in FIG. 3A, in step S502. To do this, the system controller 409 detects only the guide information relating to programs currently broadcast through channels from the guide information stored in the first storage unit 408, and controls the detected guide information to be transmitted to the graphics engine 411. The system controller 409 detects only the information corresponding to outline information from the guide information stored in the second storage unit 413 and controls the detected outlined guide information to be transmitted to the graphics engine 411. Accordingly, as shown in FIG. 3A, a screen overlapped by the broadcasting program guide information is displayed.

If it is determined in step S503 that control information has been received via the command applier 410 and it is determined in step S504 that the received control information corresponds to a request for a list of broadcasting programs by category, the system controller 409 displays the list of broadcasting programs by category on the simplified EPG area 211, in step S505. The broadcasting programs are categorized based on their content, such as, movies, sports, or news (but is not limited thereto). The list of broadcasting programs by category is pre-set by the system controller 409, which transmits the pre-set information relating to the list of broadcasting programs by category to the graphics engine 411, and controls the graphics engine 411 so that the transmitted list information is displayed on the display unit 406.

If it is determined in step S506 that the command applier 410 designates a category, the system controller 409 controls the system so that a list of programs by broadcasting stations corresponding to the designated category is displayed in step S507. To be more specific, the list of programs by broadcasting stations is detected from the first storage unit 408 using the designated category and then transmitted to the graphics engine 411. The list of programs by broadcasting stations is displayed either in the area B of FIG. 3A or alternatively, on the entire screen as shown in FIG. 1.

If it is determined in step S504 that a category list is not requested, the method goes back to step S503. If it is determined in step S506 that no category is designated, the process waits until a category is designated.

Meanwhile, if it is determined in step S503 that control information is received and it is determined in step S508 that the received control information corresponds to a request for information relating to a channel other than the displayed channel, a guide list of programs for the next channel is displayed in step S509. In other words, if guide information relating to a channel other than the displayed channel is requested through an upward and downward moving key or button installed in the command applier 410, the system controller 409 controls the first storage unit 408 and the graphics engine 411 so that guide information relating to the requested channel is provided.

If it is determined in step S503 that control information is received and it is determined in step S510 that the received control information corresponds to a request for “full EPG”, the system controller 409 controls the first storage unit 408, the graphics engine 411, and the image signal processor 405 so that the TV image is scaled down and EPG information is displayed on the entire screen, in step S511. Hence, a screen as shown in FIG. 1 is displayed. Thereafter, the method goes back to step S503.

If it is determined in step S503 that control information is received and it is determined in step S512 that the received control information corresponds to a request for selection of a highlighted program, the system controller 409 controls the second storage unit 413 and the graphics engine 411 so that detailed information relating to a selected highlight program is displayed as shown in FIG. 3B, in step S513. Thereafter, the method goes back to step S503.

If it is determined in step S503 that control information is received and it is determined in step S514 that the received control information corresponds to a request for selection of a channel, the system controller 409 performs a routine for tuning a selected channel, in step S515.

If it is determined in step S503 that control information is received and it is determined in step S516 that the control information received from the command applier 410 corresponds to an exit signal, the system controller 409 terminates the current operation. That is, as described above with respect to FIG. 2, the screen can return to the previous screen or to the screen 200.

Steps S503, S504, S508, S510, S512, S514, and S516 can be expressed as a single step for determining the command received from the command applier 410. Alternatively, steps S503, S504, S508, S510, S512, S514, and S516 may be performed sequentially.

The present invention has various advantages. For example, but not by way of limitation, according to the above-described present invention, guide information relating to broadcasting programs is displayed by partially overlapping a program that is currently being watched. The area of a screen that is overlapped by guide information relating to broadcasting programs is minimized to provide a screen for the program being currently watched. Therefore, interruption of a program being currently watched due to provision of guide information on the same screen can be substantially prevented.

In addition, when guide information relating to broadcasting programs is requested, guide information relating to programs currently provided through different channels is provided, which facilitates channel navigation. Thus, a channel can be quickly selected by the user.

Furthermore, detailed guide information relating to highlight or recommended broadcasting programs designated by broadcasting stations or channels is provided, which diversifies the type of guide information relating to broadcasting programs that can be provided. From various guide information, a desired broadcasting program can be easily selected.

While the present invention has been particularly shown and described with reference to preferred embodiments thereof, it will be understood by those of ordinary skill in the art that various changes in form and details may be made therein without departing from the spirit and scope of the present invention as defined by the following claims.

What is claimed is:

1. A method of providing guide information relating to broadcasting programs, comprising:
detecting guide information relating to said broadcasting programs currently broadcast through channels from stored guide information if the guide information relating to broadcasting programs is requested; and
displaying the detected guide information.

2. The method of claim 1, wherein in the display step, the detected guide information is displayed in only a part of a displayable area.

3. A method of providing guide information relating to broadcasting programs, comprising:
receiving and storing guide information relating to highlighted or recommended programs designated by a channel or a broadcasting station; and
displaying outline information from the guide information stored in the storing step, if the guide information relating to broadcasting programs is requested.

4. The method of claim 3, wherein in the display step, the outline information is displayed in only a part of a displayable area.

5. The method of claim 3, wherein the outline information includes a still image or an icon corresponding to at least one of the broadcasting programs.

6. The method of claim 3, wherein the outline information includes a snapshot or a moving picture corresponding to at least one of the broadcasting programs.

7. The method of claim 3, wherein when outline information relating to a desired program is selected, the display step further includes a substep of detecting detailed guide information relating to the selected desired program from the guide information, and displaying the detected detailed guide information.

8. The method of claim 3, wherein in the receiving and storing step, guide information relating to the highlighted or recommended programs is received from a communications network.

9. A method of providing guide information relating to broadcasting programs, comprising:
detecting guide information included in a received broadcasting signal as first guide information, and storing the detected first guide information;
receiving guide information relating to highlighted or recommended programs designated by channels or broadcasting stations through a network, and storing the received guide information as second guide information;
detecting as third guide information guide information relating to programs being currently broadcast through channels from the first guide information, if the guide information relating to broadcasting programs is requested; and
displaying the second and third guide information.

10. The method of claim 9, wherein in the display step, the second and third guide information is displayed in only a part of a displayable area.

11. The method of claim 9, wherein when guide information by a broadcasting category is requested, further comprising displaying pre-set guide information by the broadcasting category in an area in which the third guide information is displayed.

12. The method of claim 9, wherein when the first guide information is requested while the second and third guide information are displayed, further comprising displaying the first guide information over the entire displayable area.

13. The method of claim 9, wherein when a program is selected from the displayed second guide information, the display step further includes displaying the detailed information relating to the selected program.

14. The method of claim 9, wherein when a channel is selected from the displayed third guide information, the method further comprises performing a routine for tuning the selected channel.

15. An apparatus for providing guide information relating to broadcasting programs, comprising:
a guide information detector for detecting guide information from a received broadcasting signal;
a storage unit for storing the detected guide information;
a system controller for controlling the storage unit so that the storage unit outputs guide information from the stored guide information relating to programs currently broadcast through channels, if a user requests guide information; and
a display unit for displaying the guide information output from the storage unit in only a part of a displayable area of the display unit.

16. The apparatus of claim 15, further comprising a graphics engine for forming a display format of the stored guide information so that the display unit displays the guide information in only said part of the displayable area of the display unit.

17. The apparatus of claim 15, wherein if a channel is selected from the guide information displayed on the display unit, the system controller controls said apparatus so that the selected channel is tuned.

18. An apparatus for providing guide information relating to broadcasting programs, comprising:
a storage unit for receiving guide information relating to a highlighted program or a recommended program designated by a channel or a broadcasting station via a communication network, and storing the received guide information;
a system controller for controlling the storage unit so that the storage unit outputs outline information from the stored guide information, if a user requests the guide information; and
a display unit for displaying the outline information output from the storage unit in only a part of a displayable area.

19. The apparatus of claim 18, wherein the outline information includes a still image or an icon corresponding to at least one of the broadcasting programs.

20. The apparatus of claim 18, wherein the outline information includes a snapshot or a moving picture corresponding to at least one of the broadcasting programs.

21. The apparatus of claim 18, further comprising a graphics engine for forming a display format of the outline information so that the outline information can be displayed in only the part of the displayable area.

22. The apparatus of claim 18, wherein if a portion of the outline information is selected from the displayed outline information, the system controller controls the storage unit so that the storage unit outputs detailed information corresponding to the selected outline information.

23. An apparatus for providing guide information relating to broadcasting programs, comprising:
a guide information detector detecting guide information from a received broadcasting signal;
a first storage unit storing as first guide information the guide information detected by the guide information detector;
a second storage unit storing as second guide information guide information relating to a highlighted or recommended program designated by at least one channel or at least one broadcasting station through a network;
a system controller controlling the first storage unit so that the first storage unit outputs as third guide information guide information relating to programs being currently broadcast through at least one channel among the first guide information, if a user requests the guide information relating to broadcasting programs, and controlling the second storage unit so that the second storage unit outputs as fourth guide information outline information among the second guide information; and
a display unit displaying the third and fourth guide information in only a part of a displayable area of the display unit.

24. The apparatus of claim 23, wherein when a portion of guide information is selected from the fourth guide information, the system controller controls the second storage unit so that the second storage unit outputs the detailed information relating to the selected guide information, and the display unit displays the detailed information.

25. The apparatus of claim 23, wherein if the first guide information is requested while the third and fourth guide information is displayed, the system controller controls the first storage unit so that the first storage unit outputs the first guide information and controls the display format so that the first guide information is displayed over the entire displayable area of the display unit.

26. The apparatus of claim 23, wherein said network comprises the Internet.

27. The apparatus of claim 18, wherein said communication network comprises the Internet.

28. The method of claim 9, wherein said network comprises the Internet.

29. The method of claim 8, wherein said communications network comprises the Internet.
